(19) United States
(12) Patent Application Publication
(10) Pub. No.: US 2007/0082172 A1
(43) Pub. Date: Apr. 12, 2007

(54) Composite materials

(76) Inventors: Daniel B. Derbyshire, Cary, NC (US); James Garry Hough, Mooresville, NC (US); Steven P. Ottone, Cary, NC (US)

Correspondence Address: WOMBLE CARLYLE SANDRIDGE & RICE, PLLC, ATTN: PATENT DOCKETING 32ND FLOOR, P.O. BOX 7037, ATLANTA, GA, 30357-0037, US

(21) Appl. No.: 11/542,359

(22) Filed: Oct. 3, 2006

Related U.S. Application Data
(60) Provisional application No. 60/723,141, filed on Oct. 3, 2005.

(51) Int. Cl. B32B 33/00; B32B 3/02

(52) U.S. Cl. 428/95; 428/96; 156/308.2

(57) ABSTRACT

A noise reducing composite material for use in automotive applications, and methods for preparing the material, are disclosed. The composite includes a carpet layer and a noise reducing layer. The carpet layer can be a tufted carpet layer that includes a primary backing in which to position tufts of yarn, and a latex layer to lock in the tufts of yarn, or a nonwoven carpet layer with a coating of latex to lock in the fibers. The noise reducing layer is adhered to the carpet layer. The latex layer includes, as an additive, an adhesive of sufficient type and quantity to adhere the noise reducing layer to the carpet layer. Latex dispersions including such additives, which can be used to form the latex layer in the composite material, are also disclosed. Examples of noise reducing layers include heavily filled EVA, shoddy, and foam layers. For adhering shoddy and/or foam layers, the additive in the latex layer is a polyolefin, such as polyethylene. For adhering filled EVA layers, the additive in the latex layer is a water-based adhesive such as an ethylene acrylic acid ammoniated dispersion. The composite carpet materials described herein represent an improvement over the existing carpet materials, in that they can be manufactured using wet steps, without the need for organic solvents, and reduce the number of process steps by eliminating the need for an extruded polyethylene layer.

This application claims benefit of U.S. Provisional Application No. 60/723,141, filed on Oct. 3, 2005.

### FIELD OF THE INVENTION

The present invention relates generally to fabrics, and more particularly to automotive tufted or nonwoven carpet having desired physical properties, including moldability and acoustical performance.

### BACKGROUND OF THE INVENTION

In automobiles and other vehicles, it is desirable to reduce the level of noise within the vehicle passenger compartment. Noises, such as road noise, engine noise, vibrations, etc., can be attenuated by using various acoustically absorptive (or reflective) materials. For example, sound attenuating materials are conventionally provided in conjunction with carpeting for floor panels, upholstery for door panels and headliners, and the like.

In general, the ability of conventional materials to attenuate sound increases as the amount of material increases. Unfortunately, the use of increased materials tends to increase the weight and/or thickness of the sound attenuating material, which can be undesirable. Accordingly, there is a continuing need for sound attenuating materials that exhibit superior noise reducing properties, while also being relatively thin, lightweight, and low in cost.

Tufted carpeting for automobiles can be prepared by tufting yarn into a primary backing of woven jute or the like. The underside of the primary backing (the side underneath the visible carpet) is typically coated with latex or another adhesive to lock in the stitches. Alternatively, lightweight materials such as woven polypropylene tape and polyester spunbonds can be used as a carpet primary backing through which yarn is tufted, and a secondary backing of a stable material is optionally adhered to the back of the carpet. Polypropylene and polyester formed from either woven, non-woven or spunbond materials are examples of such materials. Such backings can be preferred due to their light weight and performance.

Alternatively, the carpet may be a non-woven carpet. Non-woven carpets can be manufactured by layering fiber, such as polyester, in a cross lap configuration to form a thick mat. The mat is then needled to entangle the fiber and consolidate the mat. An optional step can include a secondary needling operation to provide an aesthetic surface. The underside of the carpet (the side underneath the aesthetic surface) is typically coated with latex or another adhesive to lock in the fibers and provide dimensional stability among other properties.

For improved noise reduction, these carpet layers are often coupled with a noise reducing layer. For example, materials for automotive use can include a conventional tufted carpet layer as discussed above, a noise reducing layer, and an adhesive layer such as an extruded polyethylene layer to adhere the carpet layer and noise reducing layer. The adhesive layer is typically activated under conditions of heat and/or pressure, such as those used to mold the composite material into a desired shape.

In one method, a noise reducing layer, such as filled ethylene vinyl acetate (EVA) is extruded into a sheet and rolled up. Later, it is unrolled and a layer of polyethylene (PE) hot melt adhesive is extruded onto the filled EVA layer. The composite PE/EVA material is then rolled up until it is to be coupled to the carpet layer to form a noise reducing composite material. This process is relatively inefficient, in that the EVA material must be unrolled, the PE layer extruded on the EVA material, and the PE/EVA composite material re-rolled. Another traditional method for adhering a filled EVA layer to the carpet layer has involved applying a PE layer to the underside of the carpet layer, and then applying the filled EVA layer to the PE/carpet layer composite. This process is also relatively inefficient, for the same reasons.

It would be advantageous to provide noise reducing composite materials including a carpet layer and a noise reducing layer, which does not include a separate adhesive layer, post applied to either layer. These materials ideally would be moldable and also provide acceptable acoustical and other properties for use in automobiles. Such materials and methods would reduce the processing cost and increase the process efficiency. The present invention provides such materials and methods.

### SUMMARY OF THE INVENTION

A noise reducing automotive tufted or nonwoven carpet/noise reducing layer composite material, which provides acceptable noise reducing properties when used in automotive applications, is disclosed. Methods of making and using the material are also disclosed.

The composite includes a carpet layer and a noise reducing layer. The carpet layer includes either a primary backing in which to position tufts of yarn, and a latex layer to lock in the tufts of yarn, or a nonwoven carpet and a coating of latex to lock in the fibers. The noise reducing layer is adhered to the carpet layer. The latex layer includes, optionally an additive of sufficient type and quantity to adhere the noise reducing layer to the carpet layer, when the adhesive is activated under conditions of heat and/or pressure such as would be used to mold the composite. Latex dispersions including such additives, which can be used to form the latex layer in the composite material, constitute a separate embodiment of the invention.

The composite can be formed by first preparing a carpet layer. Next, the latex which optionally includes an additive for adhering the noise reducing layer to the carpet layer is applied to the back of the carpet layer to lock in the stitches of yarn in the carpet layer. Finally, a noise reducing layer is applied to the carpet layer, under conditions of heat and/or pressure, optionally while molding the composite material into a desired shape.

The carpet primary backing can be a woven or non-woven material, and can be formed from natural products such as jute, hemp, flax, or synthetic polymers such as nylon, polypropylene and polyester. Examples of non-wovens include spun bond non-wovens, air-laid non-wovens, and wet-laid non-wovens.

The yarn can be any type of yarn suitable for automotive carpets. Examples include synthetic polymers such as nylon, polypropylene, polytrimethylene tetraphthalate, polyester, and acrylic, and natural materials such as wool or cotton.

The coating material can be any suitable latex-type product for locking in the stitches of yarn to the backing material. Examples include acrylic latexes, styrene-butadiene copolymer latexes, carboxylated styrene butadiene, vinylidene chloride butadiene latexes, styrene butadiene vinylidene chloride latexes, carboxylated styrene butadiene acrylonitrile latexes, vinyl acetate ethylene latexes, latexes based on polyolefin emulsions or dispersions (such as polyethylene, polyethylene terephthalate, polypropylene), polyvinyl acetate latexes, polyvinyl chloride latexes and the like.

The noise reducing layer can be any suitable layer for reducing automotive noise. Heavily filled materials can be used, and EVA polymers, with their ability to accept up to about 80% by weight of fillers, can be a preferred heavily filled material. Keldex® is an example of a commercially available filled EVA layer. Shoddy (i.e., “fiberized” or shredded recycled apparel and waste fibers, needled and resin treated), and variants such as cotton shoddy and synthetic shoddy, can also be used. Foam layers can also be used.

The latex dispersion used to prepare the latex layer can include one or more additives suitable for adhering the noise reducing layer. The latex dispersion can be applied to the carpet using any conventional application means, including spray, rollers and blades.

For adhering shoddy and/or foam, the most commonly used additives are polyolefins, such as polyethylene, polypropylene, and other C₂₋₅ polyolefins and copolymers thereof. Polyethylene, particularly low molecular weight polyethylene, is a preferred polymer. The polyolefin adhesive can be in the form of relatively small particles, co-dispersed in the latex dispersion with the polymers that make up the latex layer. The concentration of the particles is generally in the range of about 1 part to about 200 parts per hundred dry latex, ideally between about 30 and about 80 parts per hundred, of the dry latex.

For adhering filled EVA layers, water-based additives are preferred. Additives based on styrene-butadiene, ethylene acrylic acid, polyvinyl acetate (PVAC) and vinyl acetate-ethylene (VAE) and rosin ester tackifiers can be used, and of these, ethylene acrylic acid additives can be preferred. An example of a suitable ethylene acrylic acid additive is an ethylene acrylic acid ammoniated dispersion, i.e. a dispersion sold under the trade name Michem® prime. In one embodiment, the amount of water-based additive can be reduced, or the additive can be eliminated altogether, by adjusting the carboxylation level in the polymer. Carboxylic acid levels can range from 0.1 to 20.0 based on monomer, with a preferred range of 4 to 12, and can be selected from vinyl acids such as but not limited to acrylic acid, itaconic acid, fumeric acid, methacrylic acid, and the like.

The composite can be prepared, for example, by first forming the carpet layer, and then adhering the noise reducing layer under conditions of heat and/or pressure, optionally while molding the composite into a desired shape. After the yarn is stitched in place in the backing layer to form a tufted carpet layer, or a non-woven carpet layer is formed, a latex dispersion (including the additive for adhering the noise reducing layer) is applied to lock in the tufts of the tufted carpet layer or to coat the back of the non-woven carpet layer. The latex dispersion is then dried.

Then, the carpet layer and/or the noise reduction layer are heated, the two layers are mated, and then added to the tool where pressure is used to adhere the two layers. The carpet can be molded in this step, if desired. Alternatively, the carpet and noise reducing layer can be mated and heat applied to the noise reducing layer. Then, pressure is applied to the mated composite structure to bond them. The carpet can be molded in this step, if desired.

In one embodiment, the carpet layer is replaced with a fabric layer, such as vinyl, and the layer is used as upholstery for various interior portions, such as headliners, dashboards, etc.

In one embodiment, a layer of acoustic fiber batting and/or an acoustic foam material, which can be elastic or inelastic, is adhered to the underside of the noise reducing layer (optionally using a polyolefin adhesive layer).

The composite materials can be used in various automotive applications in which sound attenuation is required, including, carpeting for floors, door panels, and other interior portions of the car. They possess acceptable sound-absorbent properties for use as conventional automobile carpets, while avoiding the use of the polyethylene adhesive layer, and avoiding unnecessary process steps.

The sound attenuation properties of the composite carpet materials described herein can be “tuned” to provide desired sound deadening and absorption properties in selected vehicle locations, such as floor pans, door panels, etc. The term “tuned” means that portions of a composite article can be formed to have a specific acoustic impedance designed to attenuate sound in one or more frequencies or frequency bands. Moreover, the composite materials can have reduced overall weight compared with conventional sound proofing materials, without sacrificing their sound attenuation properties.

The composite carpet materials described herein represent an improvement over the existing carpet materials, in that they can be manufactured using wet steps, without the need for organic solvents, and reduce the number of process steps by eliminating the need for an extruded polyethylene layer. The resulting product also can have a relatively lower weight, which can be important for automotive uses.

### BRIEF DESCRIPTION OF THE FIGURES

Certain objects of the present invention will become evident as the description proceeds when taken in connection with the accompany drawings, as briefly described below:

FIG. 1 is a diagram showing the conventional apparatus for extruding a polyethylene (PE) adhesive film on a filled ethylene vinyl acetate (EVA) noise reducing layer. 10 is a roll with filled EVA. 20 is a hopper containing PE. 30 is an extruder, where a thin layer of PE (40) is extruded onto a layer of filled EVA (50). The PE/EVA composite (60) is then rolled up (70) for use in preparing the finished carpet product.

FIG. 2 is a diagram showing the conventional apparatus for extruding a polyethylene (PE) adhesive film on a carpet layer. 80 is a roll of carpet. 20 is a hopper with PE. 30 is an extruder, where a thin layer of PE (40) is extruded onto the carpet layer (90). The PE/carpet layer composite (100) is then rolled up (110) for use in preparing the finished carpet product.

FIG. 3 is a diagram showing the composite materials described herein. A filled EVA noise reducing layer (50) is applied over a carpet layer (90) with a layer of latex including an additive sufficient to adhere the noise reducing layer (120) and compression molded using a compression molding apparatus (not shown) to form the final product.

### DETAILED DESCRIPTION OF THE INVENTION

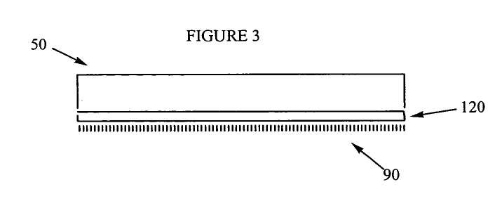

The present invention is now described more fully with reference to the accompanying drawings, particularly with respect to FIG. 3, which represents an example of the composite materials described herein. This invention can, however, be embodied in many different forms, and FIG. 3 should not be construed as limited to the embodiments set forth herein. Rather, these embodiments are provided so that this disclosure will be thorough and complete, and will fully convey the scope of the invention to those skilled in the art.

In the drawings, the thickness of lines, layers and regions may be exaggerated for clarity. It will be understood that when an element such as a layer, region, substrate, or panel is referred to as being “on” another element, it can be directly on the other element or intervening elements can also be present. In contrast, when an element is referred to as being “directly on” another element, there are no intervening elements present. It will be understood that when an element is referred to as being “connected” or “attached” to another element, it can be directly connected or attached to the other element or intervening elements can also be present. In contrast, when an element is referred to as being “directly connected” or “directly attached” to another element, there are no intervening elements present.

The invention is directed to sound attenuating composite carpet materials for use in various applications, which include, but are not limited to, recreational vehicles (RV's), airplanes, trains, buses and, particularly, automotive applications. Exemplary automotive applications within which the sound attenuating composite carpet materials can be used include carpeting for trunk components, floors, door panels, and other interior portions, and upholstery for various interior portions, such as headliners, dashboards, and the like.

The individual components used to form the composite material, and methods for preparing the composite material, are described in more detail below.

I. Composite Carpet Material

The composite carpet material includes a carpet layer, a latex layer, and a noise reducing layer. The latex layer is used in connection with tufted carpet layers to lock the stitches of the carpet into a backing layer, and also includes an additive to adhere the carpet layer to the noise reducing layer. The latex layer is used in connection with non-woven carpet layers to lock in the fibers. The latex layer is formed from a latex dispersion which may include an additive to adhere the carpet layer to the noise reducing layer.

The individual components are described more fully below.

Carpet Layer

The carpet layer can be a woven, tufted or non-woven carpet layer. The layer can include a blend of one or more types of fibers that is attached to a surface of the noise reducing layer in a back-to-face relationship, meaning that the noise reducing layer is attached to the underside or the non appearance side of the carpet, as illustrated in FIG. 3.

Tufted Carpet Layers

The tufted carpet layer is formed from a carpet backing, with yarn stitched through the backing. The carpet layer typically has a thickness of about four to ten millimeters (4-10 mm), and a mass of between about 0.3 and 1.0 Kg/m², although thicknesses and densities greater than or less than these values can be used.

The carpet primary backing can be prepared from any conventional woven, non-woven or spunbond material, although it is typically formed from polypropylene (PP), polyethylene (PE), terephthalate/polypropylene (PET/PP), polyethylene terephthalate/polyacrylic (PET/PA), polyamide (nylon) and/or polyethylene terephthalate (PET) polymers. Tufts of pile yarn are stitched or sewn through the backing, and a latex layer is applied to hold the tufts together.

When the backing layer is a spun bonded polyester fiber, the density of the backing layer typically ranges from about seventeen grams per square meter to about one hundred fifty grams per square meter (17-150 g/m²). Another specific type of backing layer that can be used is polyethylene terephthalate (PET) LUTRADUR® Style 52, manufactured specifically for tufted automotive carpets by Freudenburg Nonwovens NA. The backing layer typically weighs between about 80 and 140 grams/m².

Although many different types of tufted carpet can be used, yarns prepared from materials such as wool, cotton, acrylic, polypropylene, polyethylene terephthalate (polyester), and nylon (polyamide), polyester and nylon can be preferred.

Those of skill in the automotive tufted carpet art will understand that even with the mechanical lock for the tufts of yarn that have been stitched through the carpet backing, the latex layer used to back-coat the carpet helps ensure that the tufts will not pull out.

Non-Woven Carpet Layers

The carpet layer can be a non-woven carpet layer. The non-woven layer is typically between about three to ten millimeters (3-10 mm) in thickness and typically includes substantially all synthetic fibers such as polyester, nylon and the like.

As used herein, non-woven fabric is defined as an assembly of textile fibers joined by mechanical interlocking in a random web or mat, by fusing (in the case of thermoplastic fibers), or by bonding with a cementing medium, such as the latex compositions described herein.

Such carpet layers are typically manufactured by layering fiber, such as polyester, in a cross lap configuration to form a thick mat. The mat is then needled to entangle the fiber and consolidate the mat. In a needle punching (needling) process, carpet fibers are punched by a series of barbed needles which causes them to mechanically interlock and form a non-woven loose fabric structure. Alternatively, the fibers can be held together in the layer by air layering. Optionally, a secondary needling operation can be performed to provide an aesthetic surface.

The underside of the carpet (the side underneath the aesthetic surface) is then coated with a latex composition as described herein. This latex coating locks in the fibers and provides dimensional stability and body, among other properties. The latex coating also helps to prevent or minimize fiber loss, which is often a serious problem associated with automotive carpeting.

In one embodiment, the non-woven carpet is produced by needling a fibrous batt of polyolefin fiber to partially compress and strengthen the batt, and to create a smooth face and a pile face from which polyolefin fiber ends slightly protrude. The pile face of the batt is then heated to fuse the fiber ends to form balls on the ends of the fibers. The density of this first fiber batt is typically in the range of about 1.5 to about 6 ounces per square yard. A second batt can be placed over the pile face and needled to the first batt. This combination can then be coated with latex and then coupled to a noise reduction layer, as described herein.

Machines and methods for preparing non-woven carpet layers are known in the art, and are described, for example, in U.S. Pat. No. 3,957,568, the contents of which are hereby incorporated by reference.

Latex Dispersion and Resulting Latex Layer

The latex dispersion used to coat the carpet layer contains latex particles such as acrylic, styrene-butadiene copolymer, carboxylated styrene butadiene, vinylidene chloride butadiene, styrene butadiene vinylidene chloride, carboxylated styrene butadiene acrylonitrile, vinyl acetate ethylene, polyvinyl acetate, polyvinyl chloride, polyolefin emulsions or dispersions (such as polyethylene, polyethylene terephthalate, polypropylene), and the like. Commonly, a latex formulation is calculated based on 100 dry parts of rubber (latex) and is designated as 100 dry phr.

The latex formulation may further contain materials such as antioxidants, UV stabilizers, dispersants, and antimicrobials to enhance and extend the performance of the latex. Such additives are well known to those familiar with the art of latex production. Typically these additives make up less than 5% of the weight of the latex and are considered as part of the 100 dry phr of latex.

The latex dispersion may further contain inorganic fillers such as calcium carbonate (ground or precipitated), talc, aluminum silicate (such as Kaolin clay), alumina trihydrate, barium sulfate, calcium sulfate, fly ash and other fillers known to those skilled in the art. Typically, the level of filler will be from about 0 to about 600 phr with a more preferred range of about 50 to about 200 phr.

Pigments such as carbon black, calcium carbonate, titanium dioxide and/or other organic or inorganic pigments may be added to achieve the desired color of the final formulation. Typically, pigments are added in a range of about 0 to about 100 phr, with a preferred range of about 0 to about 20 phr.

To allow for filler retention, fiber wetting and froth application of the dispersion to the carpet backing, surfactants or a combination of surfactants may be added to the dispersion. These surfactants can be materials such as lauryl sulfates, lauryl alcohols, fluorocarbon based, succinimates, phosphates, polyacrylates and others known in the art. The surfactants are typically added in a range of about 0 to 25 phr, and, more preferably, in a range of about 0 to 8 phr.

Often for ease of application and filler retention, a thickener or combination of thickeners will be added to the formulation. Common thickeners fall in the following classes: polyacrylic, cellulosic, poly vinyl alcohols, gums and the like, and are typically added in a range of 0 to 25 phr, and more preferably in the 0 to 8 phr range.

Additives to promote adhesion to the noise reduction layers include polyolefins, such as polyethylene, polypropylene, and other C₂₋₅ polyolefins and copolymers thereof. Polyethylene, particularly low molecular weight ground polyethylene, is a preferred polymer. Further, additives based on styrene-butadiene, ethylene acrylic acid, polyvinyl acetate (PVAC), vinyl acetate-ethylene (VAE) and rosin ester tackifiers can be used, and of these, ethylene acrylic acid additives can be preferred. These additives are typically added in a range of about 0 to about 200 phr, with a more preferred range of about 0 to about 80 phr.

Based on the performance requirements of the final article, other additives such as ignition resistant additives, plasticizers, cross linkers, and the like, may be added by one skilled in the art to achieve desired properties.

Noise Reducing Layer

The noise reducing layer can be a thermoplastic material that is fused to a surface of the carpet layer. Exemplary materials for use as the noise reducing layer can include, but are not limited to, mineral filled EVA, such as Keldex®, PVC (polyvinyl chloride), and TPO (thermoplastic elastomer-olefinic). Filler levels are typically between about zero percent and about eighty percent (0-80%), depending on the application. In some embodiments, the thickness of this type of noise reducing layer is between about 1 and 3 mm.

The noise reducing layer can also be a waste-type product referred to as “shoddy” and can contain a wide variety of fibers, both natural and synthetic. Such a material can be needled or densified and be further modified using a resin such as phenolic or low melt binder fiber and heat. Variants, such as cotton shoddy and synthetic shoddy, can also be used. In some embodiments, the thickness of this type of noise reducing layer is between about 4 and 35 mm.

The noise reducing layer can also be a foam layer. Suitable foam layers for noise reduction composite materials are described, for example, in pending U.S. Patent Application Publication Nos. 2004/0216949 A1 and 2003/116379, the contents of which are hereby incorporated by reference. Exemplary foams include, but are not limited to, gel coats, latex, and sheet foams, which can be formed from polyurethane, polyolefins such as polypropylene and polyethylene, polyvinylchloride, EVA, polyester, and the like.

The thickness of the foam layer can be between about 5 mm and about 70 mm, with a preferred thickness range of between about 5 mm and about 30 mm. The foams can have a variety of different densities and/or thicknesses, and combinations of foam layers of differing densities and thicknesses can also be used.

Optional Additional Layers

In one embodiment, a layer of acoustic fiber batting and/or an acoustic foam material, which can be elastic or inelastic, is adhered to the underside of the noise reducing layer (optionally using a polyolefin adhesive layer). In another embodiment, a polyethylene film is added to the structure as a water/chemical barrier.

II. Methods For Preparing the Composite Material

In those embodiments where the carpet layer is a tufted layer, after the carpet layer is formed, the tufts are held in place by a latex layer. Similarly, in those embodiments where the carpet layer is a non-woven layer, after the fibers are needled, a latex coating is applied. The latex is applied as an aqueous dispersion to the underside of the carpet layer, which, when set, forms the latex layer/coating. The latex dispersion can also include an additive for adhering the noise reducing layer, or can include a latex with a high degree of carboxylation, as discussed above.

The noise reducing layer is applied to the underside of the carpet layer, underneath the latex layer. Before the layers are applied together, one or both of the layers is heated. For example, the carpet can be heated, and the noise reducing layer optionally heated, the two layers mated, and added to a tool where pressure is used to adhere the two layers. The carpet can be molded in this step, if desired. Alternatively, the carpet and noise reducing layer can be mated and heat applied to the noise reducing layer. Then pressure is applied to the mated composite structure to bond them. The carpet can be molded in this step, if desired.

The carpet layer and/or noise reduction layer used to form the composite carpet material can be heated with contact heat, infrared radiation or other energy sources such as conventional ovens, hot air, microwave ovens, etc. Typically, the back side of the layer (the side which is adhered to the other layer) is heated to a temperature of between about 125° C. and about 215° C. After mating, the heated composite structure is then transferred to a press or mold and pressure is applied such that the adhesive latex layer adheres the carpet layer and the noise reducing layer. Alternatively, the carpet layer including the latex adhesive layer is heated to a temperature of between about 125° C. and about 215° C. and optionally, the noise reducing layer is heated to a temperature of between about 125° C. and about 200° C. The two layers are mated in a press or mold tool and pressure is applied such that the adhesive latex layer adheres the carpet layer and the noise reducing layer.

By appropriate selection of portions of the composite article to compress, and the amount of compression, the composite article can be “tuned” to provide desired sound deadening and absorption properties in selected vehicle locations, such as floor pans, door panels, etc. Various types of infrared ovens and compression molds can be used to produce the composite materials of the present invention.

All, or selected portions, of the sound attenuating composite carpet material can be compressed (e.g., via a mold) relative to adjacent portions so as to have an acoustic impedance that is greater than an acoustic impedance of adjacent portions. Operations for compressing selective portions of the composite carpet material are well known to those of skill in the art. For example, the composite can be passed through nip rolls under an increased temperature, or molded.

The resulting automotive carpet material possesses the requisite strength and moldability of conventional automotive tufted carpet, while also providing acceptable acoustical properties so as to assist in minimizing the noise level in an automobile.

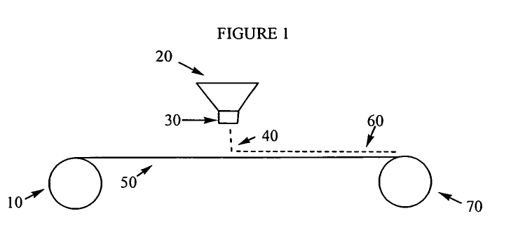

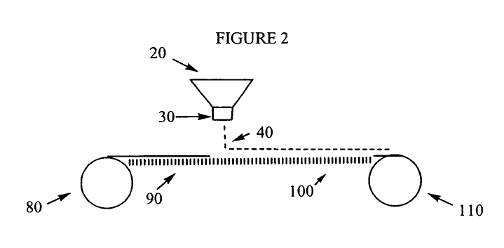

This process, and the resulting composite material, represent a significant advance in the art of automotive carpet manufacture. As shown in FIGS. 1 and 2, conventional processes for adhering a carpet layer to a noise reduction layer typically involve applying an adhesive layer to either the carpet layer or the noise reduction layer. The adhesive layer, often a thin extruded film of polyethylene, adds material cost, adds an extrusion step to the process, and adds weight to the final product. As shown in FIG. 1, a roller (10) with a roll of filled EVA is unrolled and passed under a hopper (20) with polyethylene. The polyethylene is extruded through an extruder (30) directly onto the filled EVA (50). The resulting PE/EVA composite (60) is then rolled up (70) for use in preparing the finished carpet product. As shown in FIG. 2, a polyethylene (PE) adhesive film is extruded on a carpet layer. A roll of carpet (80) is unrolled, and passed under a hopper (20) of polyethylene. The polyethylene is extruded through an extruder (30), where a thin layer of polyethylene (40) is extruded onto the carpet layer (90). The resulting PE/carpet layer composite (100) is then rolled up (110) for use in preparing the finished carpet product. The extrusions steps, and polyethylene layers, are avoided using the processes described herein.

Referring to FIG. 3, a cross section of a sound attenuating composite carpet material as described herein is illustrated. A filled EVA noise reducing layer (50) is applied over a carpet layer (90), with a layer of latex including an additive sufficient to adhere the noise reducing layer (120). The layers can be compression molded using a compression molding apparatus (not shown) to form the final product.

The invention will be understood better upon consideration of the following examples:

### EXAMPLE 1

### Adhesion of a Shoddy Layer to Tufted and Non-Woven Carpet Layers

Formulation 68874-00 was produced using the following:

| Ingredient | Dry phr |
|---|---|
| DRSL 68957-00 Latex | 100 |
| Filler | 60 |
| Microthene MN 7010 Ground PE adhesion promoter | 50 |
| Surfactant | .8 |
| Thickener | .4 |
| % Solids | 58 |
| Viscosity | 2500 |

The above formulation was frothed to an application density of 90-110 g/8 oz cup and applied to three commercially obtained carpet structures on a roll over roll 75 inch wide pilot coater.

| Carpet | Weight | | Pile | |
|---|---|---|---|---|
| Designation | oz/yd2 | Gauge | Height | Class |
| A | 17.2 | — | 0.264 | Nonwoven |
| B | 13.9 | 1/10 | 0.214 | Tufted |
| C | 18.0 | 5/64 | 0.202 | Tufted |

Shoddy adhesion was determined by preheating the coated carpet sample at 191° C. for 6 minutes while the shoddy (6 mm, 560 gsm, recycled fiber) fabric remained at room temperature. The fabric samples were mated and transferred to a hydraulic press at room temperature between two 6 mm shims. The press daylight was closed for 1 minute, but no additional pressure was applied to the platens. Two 3″×9″ sections were die cut from the composite fabric and tested for bond strength on an Instron. The average load in lbf and load/width in lbf/in was reported.

| | Coat | Shoddy | Shoddy |
|---|---|---|---|
| Carpet | Weight | Adhesion | Adhesion |
| Designation | oz/yd2 | lbf | lbf/in |
| A | 12.6 | 3.7 | 1.3 |
| B | 9.0 | 2.9 | 1.0 |
| C | 6.7 | 3.4 | 1.1 |

A control carpet was made using DRSL 68178 TML compound in a similar fashion to the samples above. There was no adhesion of the shoddy to the fabric during similar processing.

In each of the above examples, some of the shoddy fiber remained with carpet backing. This suggested some amount of internal bond failure within the shoddy fabric, thus indicating ample adhesion of the shoddy to the carpet layer.

### EXAMPLE 2

### Adhesion of a Filled EVA Layer to Tufted and Non-Woven Carpet Layers

Latex formulations were produced using the following:

Formulation

| | 3 | 1 (Control) |
|---|---|---|
| Ingredient | Dry phr | Dry phr |
| DRSL 68957-00 Latex | 100 | 100 |
| Filler | 85 | 112 |
| Pigment | 0.87 | 0.87 |
| Michem Prime 4983-40R | 20 | 0.00 |
| adhesion promoter | | |
| Surfactant | 4.05 | 4.05 |
| Thickener | .1 | .45 |
| % Solids | 57.0 | 58.0 |
| Viscosity | 2800 | 2800 |

The above formulations were frothed to an application density of 120-140 g/8 oz cup and applied to three commercially obtained carpet samples on a roll over roll 75 inch wide pilot coater.

| | Weight | Carpets | Pile | | |
|---|---|---|---|---|---|
| Designation | oz/yd2 | Gauge | Height | Class | Compound |
| 1B | 13.9 | 1/10 | 0.214 | Tufted | 1-Control |
| 1C | 18.0 | 5/64 | 0.202 | Tufted | 1-Control |
| 3B | 13.9 | 1/10 | 0.214 | Tufted | 3-Heavy Layer |
| | | | | | Adhesion |
| 3C | 18.0 | 5/64 | 0.202 | Tufted | 3-Heavy Layer |
| | | | | | Adhesion |

Heavy layer adhesion was determined by preheating the top platen of a press to 180° C. and the bottom platen to 60° C. A 12″×12″ section of carpet was mated with an 11″×11″ section of non-backed filled EVA heavy layer. A section of 12″×12″ nonwoven scrim was placed on top of the heavy layer to minimize sticking in the press. The stacked layers were placed on the bottom platen of the press between two 4 mm stops and the day light closed for 1 minute with no additional pressure. Two 2″×12″ sections were cut from the composite fabric and tested for bond strength on an Instron, with 3 pulls per sample. The average load in lbf and load/width in lbf/in was reported.

| | Coat | Heavy Layer | Heavy Layer |
|---|---|---|---|
| | Weight | Adhesion | Adhesion |
| Designation | oz/yd² | lbf | lbf/in |
| 1B | 11.2 | 0.32 | 0.16 |
| 1C | 11.0 | 2.07 | 1.03 |
| 3B | 8.0 | 4.39 | 2.19 |
| 3C | 7.9 | 13.59 | 6.80 |

The control compound in this example is Dow Reichhold Specialty Latex 68178, a traditional thermomoldable latex compound. The results show a dramatic increase in heavy layer adhesion, by virtue of using the experimental compound. The bond was so strong in sample 3B that the tufts pulled through the primary backing and remained fully anchored to the heavy layer during testing.

### EXAMPLE 3

### Impact of Surface Acid Level on Heavy Layer Adhesion

Latexes were produced following the recipe for DRSL Tylac 68957 except carboxylic acid levels were increased by replacing 1 to 1 for styrene. The experimental latexes were formulated as in Example #2 except the Michem Prime 4983-40R was omitted. The compounds were laboratory coated on standard 19 oz/yd² nonwoven fabric. Heavy layer adhesion was then evaluated as described in Example 2. The following table shows the increase in adhesion observed by increasing the surface acid level of the latex.

| | Surface Acid level, | Heavy Layer Adhesion |
|---|---|---|
| Latex | parts | lb/in |
| Tylac 68957-27-29 control | 2.0 | 0.44 |
| 68957-30 | 3.0 | 0.59 |
| 68957-31 | 4.0 | 0.84 |

### EXAMPLE 4

A latex similar to 68957-31 in Example 3 was produced. The experimental latex was formulated as in Example 2, with and without the Michem Prime 4983-40R, and laboratory coated on standard 19 oz/yd² nonwoven fabric. Heavy layer adhesion was then evaluated as described in Example 2. The following table shows the increase in adhesion observed by adding the Michem Prime 4983-40R to the higher surface acid latex.

| | Surface Acid level, | Heavy Layer Adhesion |
|---|---|---|
| Latex | parts | lb/in |
| CMS-27-05 | 4.0 | 2.0 |
| CMS-27-05 + 20 phr | 4.0 | 4.4 |
| MP 4983-40R | | |

The above examples show that, using the processes and materials described herein, the polyolefin layer commonly used to adhere carpet layers and noise reducing layers can be avoided. This streamlines the processing of the resulting composite material, lowers the overall cost and potentially decreases the weight of the composite.

The acoustic properties of several samples prepared as described above were tested, and the carpet layer/noise reducing layer composite materials were found to be acceptable for use as an automotive tufted carpet (data not shown).

Thus, the present invention provides an automotive tufted carpet composite material that possesses the necessary dimensional stability and moldability required in the automotive market, as well as the necessary acoustic properties for use as an automotive tufted carpet.

It will be understood by those skilled in the art that the particular embodiments of the invention here presented are by way of illustration only and are meant to be in no way restrictive; therefore, numerous changes and modifications can be made, and the full use of equivalence resorted to, without departing from the spirit or scope of the invention as set forth in the appended claims.

1. An automotive tufted or non-woven carpet having acceptable acoustic properties and comprising:
(a) a carpet layer including:
(i) a backing layer formed of a woven or non-woven material;
(ii) a plurality of tufts of yarn sewn through the backing layer, and
(iii) a latex layer locking in the tufts to the backing layer, or
(iv) carpet fibers needled together to form a layer, and
(v) a coating of latex to lock in the carpet fibers; and
(b) a noise reducing layer adhered to the latex layer,
wherein the latex layer/coating includes an additive of a type, and in an amount, suitable for adhering the noise reducing layer to the carpet layer under conditions of elevated temperature.

2. The carpet of claim 1, wherein the latex is selected from the group consisting of acrylic latexes, styrene-butadiene copolymer latexes, carboxylated styrene butadiene latexes, vinylidene chloride butadiene latexes, styrene butadiene vinylidene chloride latexes, carboxylated styrene butadiene acrylonitrile latexes, vinyl acetate ethylene latexes, latexes including polyolefin emulsions or dispersions, polyvinyl acetate latexes, and polyvinyl chloride latexes.

3. The carpet of claim 1, wherein the woven or non-woven material is formed from a material selected from the group consisting of PP, PET/PP, PET/PA, nylon, PET polymers, and mixtures thereof.

4. The carpet of claim 3, wherein the woven or non-woven material comprises spunbond PET.

5. The carpet of claim 4 wherein the spunbond PET weighs between 80 to 140 grams/m².

6. The carpet of claim 1, wherein the plurality of tufts are formed from material selected from the group consisting of: PP, PET and polyamide.

7. The carpet of claim 1, wherein the noise reduction layer is filled EVA, and the additive in the latex is a water-based adhesive.

8. The carpet of claim 7, wherein the water-based adhesive is selected from the group consisting of styrene-butadiene, ethylene acrylic acid, polyvinyl acetate (PVAC), vinyl acetate-ethylene (VAE), and rosin ester tackifiers.

9. The carpet of claim 7, wherein the water-based adhesive is an acrylic acid adhesive.

10. The carpet of claim 7, wherein the water-based adhesive is an ethylene acrylic acid ammoniated dispersion.

11. The carpet of claim 7, wherein the amount of water-based adhesive is reduced, or eliminated altogether, by adjusting carboxylation level of the latex.

12. The carpet of claim 1, wherein the noise reduction layer is shoddy, and the additive in the latex is a polyolefin adhesive.

13. The carpet of claim 12, wherein the polyolefin adhesive is low molecular weight polyethylene.

14. The carpet of claim 1, wherein the noise reduction layer is a foam layer, and the additive in the latex is a polyolefin adhesive.

15. The carpet of claim 14, wherein the polyolefin adhesive is low molecular weight polyethylene.

16. A latex dispersion, comprising:
a) dispersed particles of one or more polymers suitable for forming a latex dispersion, and
b) a water-based adhesive formed of a material other than the polymers used to form the latex dispersion.

17. The latex dispersion of claim 16, wherein the water-based adhesive is selected from the group consisting of styrene-butadiene, ethylene acrylic acid, polyvinyl acetate (PVAC), vinyl acetate-ethylene (VAE), and rosin ester tackifiers.

18. The latex dispersion of claim 16, wherein the water-based adhesive is an acrylic acid adhesive.

19. The latex dispersion of claim 16, wherein the water-based adhesive is an ethylene acrylic acid ammoniated dispersion.

20. The latex dispersion of claim 16, wherein the latex is selected from the group consisting of acrylic latexes, styrene-butadiene copolymer latexes, carboxylated styrene butadiene latexes, vinylidene chloride butadiene latexes, styrene butadiene vinylidene chloride latexes, carboxylated styrene butadiene acrylonitrile latexes, vinyl acetate ethylene latexes, latexes including polyolefin emulsions or dispersions, polyvinyl acetate latexes, and polyvinyl chloride latexes.

21. A latex dispersion, comprising:
a) dispersed particles of one or more polymers suitable for forming a latex dispersion, and
b) a polyolefin adhesive.

22. The latex dispersion of claim 21, wherein the polyolefin adhesive is a low molecular weight polyethylene.

23. The latex dispersion of claim 21, wherein the polyolefin adhesive is in the form of particles, co-dispersed in the latex dispersion with the latex particles.

24. The latex dispersion of claim 21, wherein the polyolefin particles are present at a concentration range of between about 1 and about 200 parts per hundred dry latex.

25. The latex dispersion of claim 21, wherein the polyolefin particles are present at a concentration range of between about 30 and about 80 parts per hundred dry latex.

26. The latex dispersion of claim 21, wherein the latex is selected from the group consisting of acrylic latexes, styrene-butadiene copolymer latexes, carboxylated styrene butadiene latexes, vinylidene chloride butadiene latexes, styrene butadiene vinylidene chloride latexes, carboxylated styrene butadiene acrylonitrile latexes, vinyl acetate ethylene latexes, latexes including polyolefin emulsions or dispersions, polyvinyl acetate latexes, and polyvinyl chloride latexes.

27. A method of preparing an automotive tufted or non-woven carpet having acceptable acoustic properties, comprising the steps of:
a) combining a carpet layer including:
(i) a backing layer formed of a woven or non-woven material;
(ii) a plurality of tufts of yarn sewn through the backing layer, and
(iii) a latex layer locking in the tufts to the backing layer, with
a noise reducing layer,
wherein:
the noise reducing layer is positioned adjacent to the latex layer, and
the latex layer includes an additive of a type, and in an amount, suitable for adhering the noise reducing layer to the carpet layer under conditions of elevated temperature, and
b) heating the carpet layer and/or noise reducing layer layers and mating the layers for a sufficient period of time, and at a sufficient temperature, to cause the adhesive in the latex layer to couple the carpet layer to the noise reducing layer.

28. The method of claim 27, wherein the woven or non-woven material is formed from a material selected from the group consisting of: PP, PET/PP, PET/PA, nylon, PET polymers, and mixtures thereof.

29. The method of claim 27, wherein the woven or non-woven material comprises spunbond PET.

30. The method of claim 27, wherein the spunbond PET weighs between 80 to 140 grams/m².

31. The method of claim 27, wherein the carpet is a tufted carpet, and the tufts are formed from material selected from the group consisting of: PP, PET and polyamide.

32. The method of claim 27, wherein the noise reduction layer is filled EVA, and the adhesive in the latex is a water-based adhesive.

33. The method of claim 32, wherein the water-based adhesive is selected from the group consisting of styrene-butadiene, acrylic, polyvinyl acetate (PVAC) and vinyl acetate-ethylene (VAE) adhesives.

34. The method of claim 32, wherein the water-based adhesive is an acrylic acid adhesive.

35. The method of claim 32, wherein the water-based adhesive is an ethylene acrylic acid ammoniated dispersion.

36. The method of claim 32, wherein the amount of water-based adhesive is reduced or eliminated altogether, by adjusting the carboxylic acid levels in the polymer to be in a range from 0.1 to 20.0 based on the monomer used to prepare the polymer.

37. The method of claim 27, wherein the noise reduction layer is shoddy, and the adhesive in the latex is a polyolefin adhesive.

38. The method of claim 37, wherein the polyolefin adhesive is low molecular weight polyethylene.

39. The method of claim 27, wherein the noise reduction layer is a foam layer, and the adhesive in the latex is a polyolefin adhesive.

40. The method of claim 39, wherein the polyolefin adhesive is low molecular weight polyethylene.
